(19) United States
(12) Patent Application Publication
(10) Pub. No.: US 2025/0224307 A1
(43) Pub. Date: Jul. 10, 2025

(54) ANALYZER

(71) Applicant: SUBARU CORPORATION, Tokyo (JP)

(72) Inventors: Takahiro YAMAMOTO, Tokyo (JP); Yoshiyuki YOMOGIDA, Tokyo (JP); Sayako SAKAMA, Ibaraki (JP)

(21) Appl. No.: 18/973,216

(22) Filed: Dec. 9, 2024

(30) Foreign Application Priority Data
Jan. 10, 2024 (JP) 2024-002178

(51) Int. Cl. G01M 13/00; F01M 1/02; F04C 2/10

(52) U.S. Cl. CPC G01M 13/00; F01M 1/02; F04C 2/10; F01M 2001/0238

(57) ABSTRACT

An analyzer includes at least one processor and at least one memory. The at least one processor is configured to: set, as a division point, a first point at which an inner rotor and an outer rotor of a pump come into contact with each other; set, as the division point, a second point on the outer rotor that is located on an extension line connecting a center and an apex of the inner rotor; set, as a division point, a third point that changes according to an angle between a reference point and the second point; divide a chamber into sub-chambers by connection lines each connecting the center of the inner rotor and one of the first point, the second point, and the third point; and when the first and third points overlap each other, divide the chamber without using the third point overlapping the first point.

### CROSS-REFERENCE TO RELATED APPLICATIONS

The present application claims priority from Japanese Patent Application No. 2024-002178 filed on Jan. 10, 2024, the entire contents of which are hereby incorporated by reference.

### BACKGROUND

The disclosure relates to an analyzer.

In the related art, there is an oil pump that increases pressure of oil using rotation power of an engine. The oil pump includes an inner rotor and an outer rotor, and changes a gap amount between teeth to suction oil and increase pressure of oil according to rotation of the inner rotor and the outer rotor.

### SUMMARY

An aspect of the disclosure provides an analyzer including at least one processor, and at least one memory coupled to the at least one processor. The at least one processor is configured to: set, as a division point, a first point at which an inner rotor and an outer rotor of a pump come into contact with each other; set, as the division point, a second point on the outer rotor that is located on an extension line connecting a center of the inner rotor and an apex of the inner rotor; set, as the division point, a third point that changes according to an angle between a reference point and the second point; divide a chamber between the inner rotor and the outer rotor into sub-chambers by connection lines connecting (i) the center of the inner rotor and (ii) the first point, the second point, and the third point respectively; and when the first point and the third point overlap each other, divide the chamber without using the third point overlapping the first point as the division point.

### BRIEF DESCRIPTION OF THE DRAWINGS

The accompanying drawings are included to provide a further understanding of the disclosure and are incorporated in and constitute a part of this specification. The drawings illustrate an embodiment and, together with the specification, serve to describe the principles of the disclosure.

FIG. 1 is a schematic configuration diagram illustrating a configuration of an analysis system according to an embodiment.

FIG. 2 is a block diagram illustrating an example of a functional configuration of an analyzer according to the present embodiment.

FIG. 3 is a schematic configuration diagram illustrating first points of an inner rotor and an outer rotor at a predetermined rotation angle A.

FIG. 4 is a schematic configuration diagram illustrating first points of the inner rotor and the outer rotor at a predetermined rotation angle B.

FIG. 5 is a schematic configuration diagram illustrating first points of the inner rotor and the outer rotor at a predetermined rotation angle C.

FIG. 6 is a schematic configuration diagram illustrating the first points and second points of the inner rotor and the outer rotor at the predetermined rotation angle A.

FIG. 7 is a schematic configuration diagram illustrating the first points and second points of the inner rotor and the outer rotor at the predetermined rotation angle B.

FIG. 8 is a schematic configuration diagram illustrating the first points and second points of the inner rotor and the outer rotor at the predetermined rotation angle C.

FIG. 9 is a schematic configuration diagram illustrating the first points, the second points, and third points of the inner rotor and the outer rotor at the predetermined rotation angle A.

FIG. 10 is a schematic configuration diagram illustrating the first points, the second points, and third points of the inner rotor and the outer rotor at the predetermined rotation angle B.

FIG. 11 is a schematic configuration diagram illustrating the first points, the second points, and third points of the inner rotor and the outer rotor at the predetermined rotation angle C.

FIG. 12 is a diagram illustrating a method for setting the third points.

FIG. 13 is a schematic configuration diagram illustrating an example of a model for deriving pressure of oil according to the present embodiment.

FIG. 14 is a flowchart illustrating an example of control processing of the analyzer according to the present embodiment.

### DETAILED DESCRIPTION

Japanese Patent No. 6535477 discloses a numerical calculation model for calculating an operation of an oil pump including an inner rotor and an outer rotor.

Here, a chamber formed as a gap between the inner rotor and the outer rotor is divided in a rotation direction of the inner rotor by contact between teeth of the inner rotor and teeth of the outer rotor. In order to accurately predict a rotor behavior and an oil behavior of the oil pump, it is necessary to accurately calculate a volume change of each sub-chamber obtained by dividing the chamber in the rotation direction. Here, when contact points at which the teeth of the inner rotor and the teeth of the outer rotor come into contact with each other are set as division points of the chamber, and the chamber is divided into sub-chambers using the set division points, the number of sub-chambers varies according to rotation of the inner rotor and the outer rotor. This is because rotation of the inner rotor and the outer rotor causes a contact point at which the inner rotor and the outer rotor come into contact with each other to become a non-contact point or causes a non-contact point to become a contact point. When the number of sub-chambers varies, a predetermined sub-chamber that is calculated suddenly disappears or a sub-chamber that is not calculated suddenly appears, and thus a volume of each sub-chamber does not continuously change, and an error occurs in calculation of the volume of each sub-chamber. As a result, it is difficult to accurately predict a rotor behavior and an oil behavior of the oil pump.

Therefore, it is desirable to provide an analyzer capable of accurately predicting a rotor behavior and an oil behavior of an oil pump.

Hereinafter, embodiments of the disclosure will be described in detail with reference to the accompanying drawings. The dimensions, materials, other specific numerical values, and the like illustrated in the embodiments are merely examples to facilitate the understanding of the disclosure, and do not limit the disclosure unless otherwise specified. In the specification and the drawings, elements having substantially the same functions and configurations are denoted by the same reference signs, and duplicate descriptions will be omitted. Elements which are not directly related to the disclosure may be omitted in the drawings.

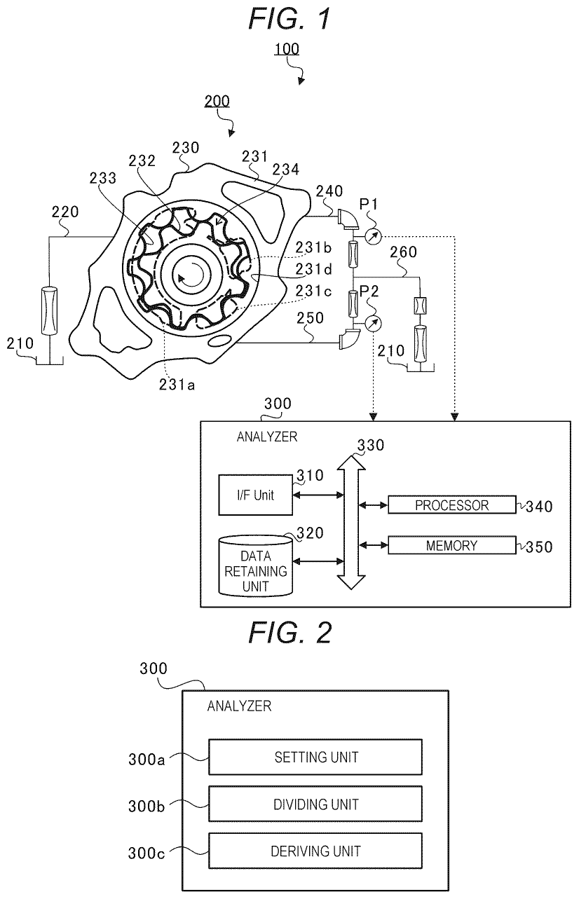

FIG. 1 is a schematic configuration diagram illustrating a configuration of an analysis system 100 according to an embodiment. As illustrated in FIG. 1, the analysis system 100 includes a hydraulic circuit 200 and an analyzer 300. The hydraulic circuit 200 includes an oil pan 210, an intake passage 220, an oil pump 230, a main discharge passage 240, a sub-discharge passage 250, and a joint passage 260.

The hydraulic circuit 200 according to the present embodiment is provided, for example, in a vehicle. For example, the hydraulic circuit 200 according to the present embodiment is a hydraulic circuit for supplying oil to each transmission unit of the vehicle. However, this is not to be construed in a limiting sense. The hydraulic circuit 200 may be, for example, a hydraulic circuit for supplying oil to each engine unit of a vehicle.

The oil pan 210 stores oil. The intake passage 220 couples the oil pan 210 to the oil pump 230. The intake passage 220 guides the oil stored in the oil pan 210 to the oil pump 230. The oil pump 230 is disposed between the intake passage 220, and the main discharge passage 240 and the sub-discharge passage 250. The oil pump 230 increases pressure of oil taken in from the intake passage 220, and discharges the oil whose pressure is increased to the main discharge passage 240 and the sub-discharge passage 250.

The oil pump 230 includes a housing 231, an inner rotor 232, and an outer rotor 233. The oil pump 230 according to the present embodiment is a so-called internal gear pump. The housing 231 has an intake port 231a, a main discharge port 231b, a sub-discharge port 231c, and a housing chamber 231d. The intake port 231a communicates between the intake passage 220 and the housing chamber 231d. The main discharge port 231b communicates between the housing chamber 231d and the main discharge passage 240. The sub-discharge port 231c communicates between the housing chamber 231d and the sub-discharge passage 250.

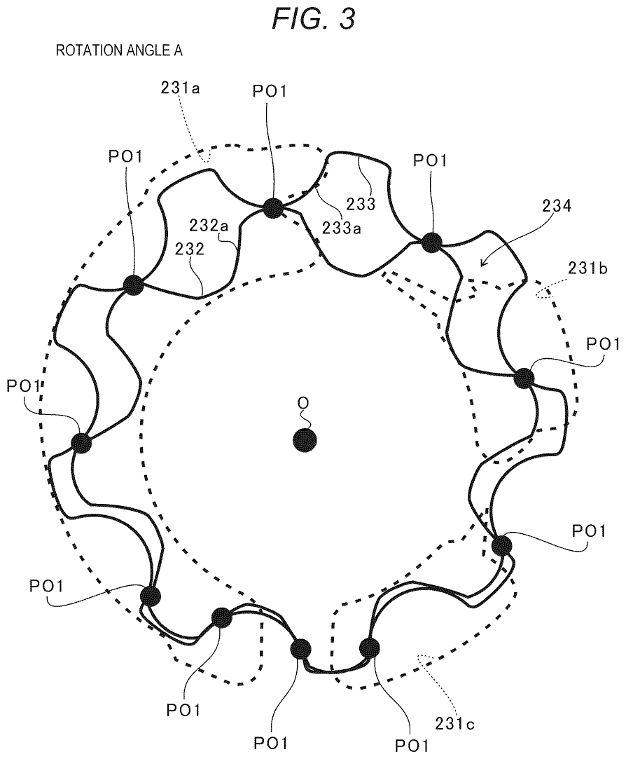

The housing chamber 231d houses the inner rotor 232 and the outer rotor 233. The inner rotor 232 and the outer rotor 233 are rotatably housed in the housing chamber 231d, and are rotated by, for example, rotation power of an engine mounted in a vehicle. The inner rotor 232 is provided with plural external teeth 232a (see FIG. 3) on an outer peripheral surface. In the present embodiment, the number of the external teeth 232a of the inner rotor 232 is eight. However, the number of the external teeth 232a of the inner rotor 232 is not limited to eight.

The outer rotor 233 is provided with a plural internal teeth 233a (see FIG. 3) on an inner peripheral surface. In the present embodiment, the number of the internal teeth 233a of the outer rotor 233 is nine. However, the number of the internal teeth 233a of the outer rotor 233 is not limited to nine. It is sufficient that the number of the internal teeth 233a of the outer rotor 233 is the number of the external teeth 232a of the inner rotor 232 plus one. A chamber 234 is formed as a gap between the inner rotor 232 and the outer rotor 233. The chamber 234 is divided into plural sub-chambers by contact between the external teeth 232a of the inner rotor 232 and the internal teeth 233a of the outer rotor 233. In the specification, the sub-chambers may also be referenced by the reference sign 234.

The inner rotor 232 and the outer rotor 233 are rotated in a rotation direction that is a clockwise direction in FIG. 1 in a state where the inner rotor 232 and the outer rotor 233 are housed in the housing chamber 231d. The chamber 234 that is divided into plural sub-chambers is partitioned in the rotation direction of the inner rotor 232 and the outer rotor 233. The inner rotor 232 includes, for example, a shaft (not illustrated) that is rotated by power of the engine. The shaft is inserted through a center of the inner rotor 232, and the inner rotor 232 is rotated integrally with the shaft.

The number of the external teeth 232a is smaller than the number of the internal teeth 233a by one, and the inner rotor 232 and the outer rotor 233 are engaged with each other in an eccentric state. When the inner rotor 232 is rotated clockwise in FIG. 1, the outer rotor 233 is rotated clockwise integrally with the inner rotor 232. At this time, the plural sub-chambers 234 between the external teeth 232a and the internal teeth 233a are repeatedly reduced and expanded in sequence.

The intake port 231a communicates with the chamber 234 in a rotation axis direction of the inner rotor 232. The intake port 231a is opened in a range of the housing chamber 231d in which a volume of each sub-chamber 234 is expanded as the inner rotor 232 and the outer rotor 233 rotate. Oil is guided from the intake port 231a to each sub-chamber 234 by a negative pressure action due to the volume expansion of each sub-chamber 234.

The main discharge port 231b communicates with the chamber 234 in the rotation axis direction at a position different from the intake port 231a in the rotation direction of the inner rotor 232. The main discharge port 231b is opened in a range of the housing chamber 231d in which the volume of each sub-chamber 234 is reduced as the inner rotor 232 and the outer rotor 233 rotate. Oil whose pressure is increased is discharged from each sub-chamber 234 to the main discharge port 231b by a compression action due to the volume reduction of each sub-chamber 234.

The sub-discharge port 231c communicates with the chamber 234 in the rotation axis direction at a position different from the intake port 231a and the main discharge port 231b in the rotation direction of the inner rotor 232. The sub-discharge port 231c is opened in a range of the housing chamber 231d in which the volume of each sub-chamber 234 is reduced as the inner rotor 232 and the outer rotor 233 rotate. Oil whose pressure is increased is discharged from each sub-chamber 234 to the sub-discharge port 231c by a compression action due to the volume reduction of each sub-chamber 234.

The main discharge port 231b is provided in the rear of the intake port 231a in the rotation direction of the inner rotor 232, and the sub-discharge port 231c is provided in the rear of the main discharge port 231b in the rotation direction of the inner rotor 232. That is, the intake port 231a, the main discharge port 231b, and the sub-discharge port 231c are provided apart from one another in the rotation direction of the inner rotor 232.

The main discharge passage 240 couples the main discharge port 231b of the oil pump 230 to the joint passage 260. The main discharge passage 240 supplies oil discharged from the oil pump 230 to cause, for example, each transmission unit to operate, and guides the supplied oil to the joint passage 260.

The sub-discharge passage 250 couples the sub-discharge port 231c of the oil pump 230 to the joint passage 260. The sub-discharge passage 250 supplies oil discharged from the oil pump 230 to lubricate, for example, each transmission unit, and guides the supplied oil to the joint passage 260.

The joint passage 260 couples the main discharge passage 240 and the sub-discharge passage 250 to the oil pan 210. The joint passage 260 recirculates oil sent out from the main discharge passage 240 and the sub-discharge passage 250 to the oil pan 210.

A main hydraulic pressure sensor P1 is provided in the main discharge passage 240. The main hydraulic pressure sensor P1 measures hydraulic pressure of oil flowing through the main discharge passage 240 and outputs a signal indicating the measured hydraulic pressure to the analyzer 300. A sub-hydraulic pressure sensor P2 is provided in the sub-discharge passage 250. The sub-hydraulic pressure sensor P2 measures hydraulic pressure of oil flowing through the sub-discharge passage 250, and outputs a signal indicating the measured hydraulic pressure to the analyzer 300.

The analyzer 300 measures a behavior of the oil discharged from the oil pump 230 based on signals output from the main hydraulic pressure sensor P1 and the sub-hydraulic pressure sensor P2. The analyzer 300 performs rotor behavior prediction for predicting behaviors of the inner rotor 232 and the outer rotor 233 of the oil pump 230 and oil behavior prediction for predicting a behavior of the oil discharged from the oil pump 230.

The analyzer 300 includes an I/F unit 310, a data retaining unit 320, a system bus 330, one or more processors 340, and one or more memories 350. The I/F unit 310 is an interface for acquiring signals output from the main hydraulic pressure sensor P1 provided in the main discharge passage 240 and the sub-hydraulic pressure sensor P2 provided in the sub-discharge passage 250.

The data retaining unit 320 includes a RAM, a flash memory, an HDD, or the like, and retains various kinds of information necessary for processing executed by the processor 340, which will be described later. For example, the data retaining unit 320 retains data acquired by the I/F unit 310. The system bus 330 is a transmission path that electrically couples the I/F unit 310, the data retaining unit 320, the processor 340, and the memory 350 to transmit data among these components.

The processor 340 includes, for example, a central processing unit (CPU). The memory 350 includes, for example, a read only memory (ROM) and a random access memory (RAM). The ROM is a storage element that stores a program used by the CPU, a calculation parameter, and the like. The RAM is a storage element that temporarily stores data such as a variable and a parameter used in processing executed by the CPU.

FIG. 2 is a block diagram illustrating an example of a functional configuration of the analyzer 300 according to the present embodiment. For example, as illustrated in FIG. 2, the analyzer 300 includes a setting unit 300a, a dividing unit 300b, and a deriving unit 300c. Various kinds of processing executed by the setting unit 300a, the dividing unit 300b, and the deriving unit 300c, which will be described below, are executed by the processor 340 executing a program stored in the memory 350. Details of the setting unit 300a, the dividing unit 300b, and the deriving unit 300c will be described later.

Here, the chamber 234 that is formed as a gap between the inner rotor 232 and the outer rotor 233 is divided in the rotation direction of the inner rotor 232 by contact between the external teeth 232a of the inner rotor 232 and the internal teeth 233a of the outer rotor 233. In order to accurately predict a rotor behavior and an oil behavior of the oil pump 230, it is necessary to accurately calculate a volume change of each sub-chamber 234 obtained by dividing the chamber 234 in the rotation direction. Here, a case where contact points at which the external teeth 232a of the inner rotor 232 and the internal teeth 233a of the outer rotor 233 come into contact with each other are set as division points of the chamber 234 will be discussed. In this case, when the chamber 234 is divided into sub-chambers using the set division points, the number of the sub-chambers 234 varies according to rotation of the inner rotor 232 and the outer rotor 233. This is because rotation of the inner rotor 232 and the outer rotor 233 causes the contact point at which the inner rotor 232 and the outer rotor 233 come into contact with each other to become a non-contact point or causes the non-contact point to become the contact point. When the number of the sub-chambers 234 varies, the predetermined sub-chamber 234 that is calculated suddenly disappears or the sub-chamber 234 that is not calculated suddenly appears, and thus a volume of each sub-chamber 234 does not continuously change, and an error occurs in calculation of the volume of each sub-chamber 234. As a result, it is difficult to accurately predict a rotor behavior and an oil behavior of the oil pump 230.

Hereinafter, a variation in the number of the sub-chambers 234 when the contact points at which the inner rotor 232 and the outer rotor 233 come into contact with each other are set as the division points of the chamber 234 will be described. Hereinafter, the contact points where the inner rotor 232 and the outer rotor 233 come into contact with each other are referred to as first points serving as the division points (hereinafter, simply referred to as a “first point” or “first points”) for dividing the chamber 234 into.

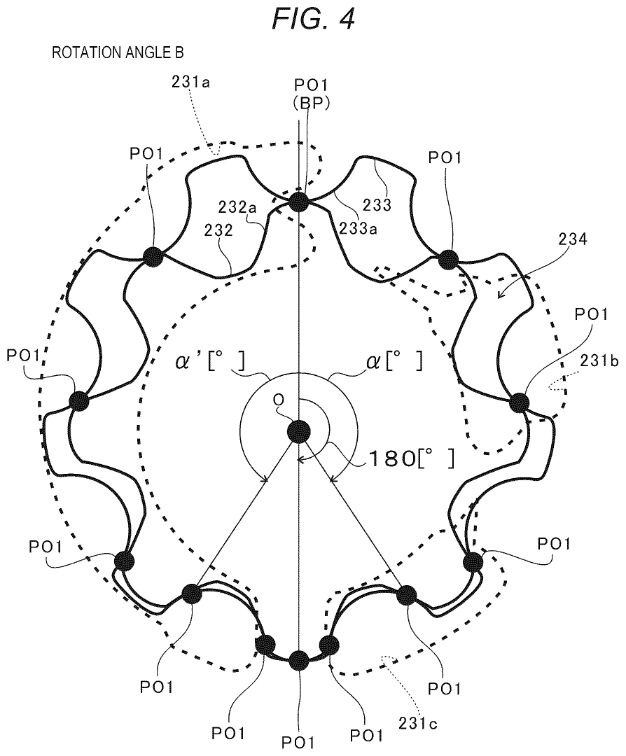

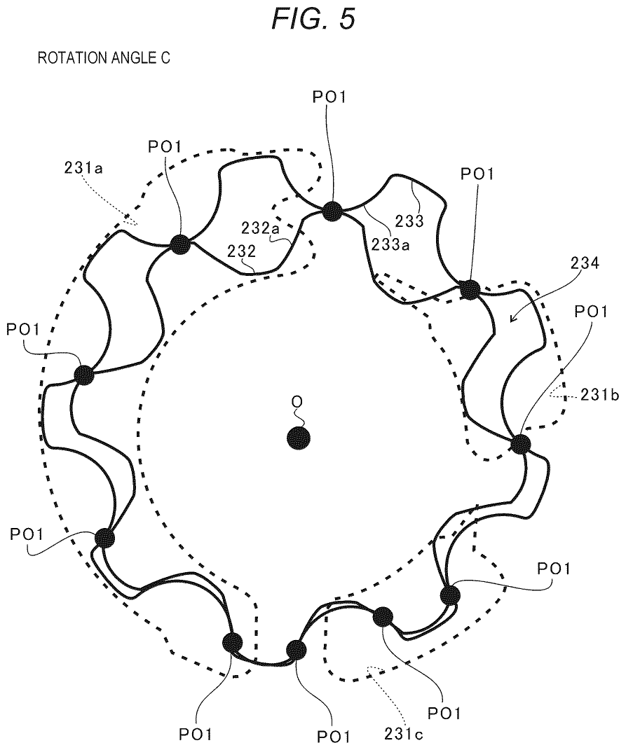

FIG. 3 is a schematic configuration diagram illustrating first points of the inner rotor 232 and the outer rotor 233 at a predetermined rotation angle A. FIG. 4 is a schematic configuration diagram illustrating first points of the inner rotor 232 and the outer rotor 233 at a predetermined rotation angle B. FIG. 5 is a schematic configuration diagram illustrating first points of the inner rotor 232 and the outer rotor 233 at a predetermined rotation angle C. Herein, the rotation angle A is an angle prior to the rotation angle B by a predetermined angle. The rotation angle C is an angle after the rotation angle B by a predetermined angle.

In FIGS. 3, 4, and 5, the first points are indicated by black circles PO1. A center point of the inner rotor 232 is indicated by 0. As illustrated in FIG. 3, at the rotation angle A, when the first points PO1 are used as the division points and the chamber 234 is divided into sub-chambers by connection lines connecting the center point O and the first points PO1, the number of the sub-chambers 234 is 10. At this time, the number of the first points PO1 is 10. Positions and rotation angles of the inner rotor 232 and the outer rotor 233 are calculated to derive the first points PO1.

As illustrated in FIG. 4, at the rotation angle B, when the first points PO1 are set as the division points and the chamber 234 is divided into sub-chambers by connection lines connecting the center point O and the first points PO1, the number of the sub-chambers 234 is 12. At this time, the number of the first points PO1 is 12. Here, as illustrated in FIG. 4, a point at which an apex of the external teeth 232a of the inner rotor 232 and an apex of the internal teeth 233a of the outer rotor 233 come into contact with each other is set as a reference point BP. A state where the first point PO1 is located at the reference point BP is set as a reference position of the inner rotor 232 and the outer rotor 233. An upper side in FIG. 4 above the center point O when the inner rotor 232 and the outer rotor 233 are at the reference position is referred to as an upper land, and a lower side in FIG. 4 below the center point O is referred to as a lower land.

As can be understood by comparing FIG. 3 and FIG. 4, when the inner rotor 232 and the outer rotor 233 move from the rotation angle A to the rotation angle B, the number of the first points PO1 increases by one at a position of a first specific angle α [°] on the rotation direction side of the inner rotor 232 relative to the reference point BP. The number of the first points PO1 increases by one at a position of 180 [ °] on a rotation direction side of the inner rotor 232 relative to the reference point BP. In this manner, when the inner rotor 232 and the outer rotor 233 move from the rotation angle A to the rotation angle B, the number of the first points PO1 increases by two in the lower land, and accordingly the number of the sub-chambers 234 also increases by two to be 12.

As illustrated in FIG. 5, at the rotation angle C, when the first points PO1 are set as the division points and the chamber 234 is divided into sub-chambers by connection lines connecting the center point O and the first points PO1, the number of the sub-chambers 234 is 10. At this time, the number of the first points PO1 is 10.

As can be understood by comparing FIG. 4 and FIG. 5, when the inner rotor 232 and the outer rotor 233 move from the rotation angle B to the rotation angle C, the number of the first points PO1 decreases by one at a position of a second specific angle α′ [°] on an opposite side to the rotation direction of the inner rotor 232 relative to the reference point BP. The number of the first points PO1 decreases by one at a position of 180[°] on the rotation direction side of the inner rotor 232 relative to the reference point BP.

In this manner, when the inner rotor 232 and the outer rotor 233 move from the rotation angle B to the rotation angle C, the number of the first points PO1 decreases by two in the lower land, and accordingly the number of the sub-chambers 234 also decreases by two to be 10.

As can be understood from the example illustrated in FIG. 4, at the position of 180[°] on the rotation direction side of the inner rotor 232 relative to the reference point BP, the number of the first points PO1 increases or decreases by one according to a rotation angle of the inner rotor 232 and the outer rotor 233. Therefore, in the present embodiment, second points are set, as division points, that are located on an inner peripheral surface of the outer rotor 233 and located on extension lines connecting the center point O and apexes of the external teeth 232a of the inner rotor 232.

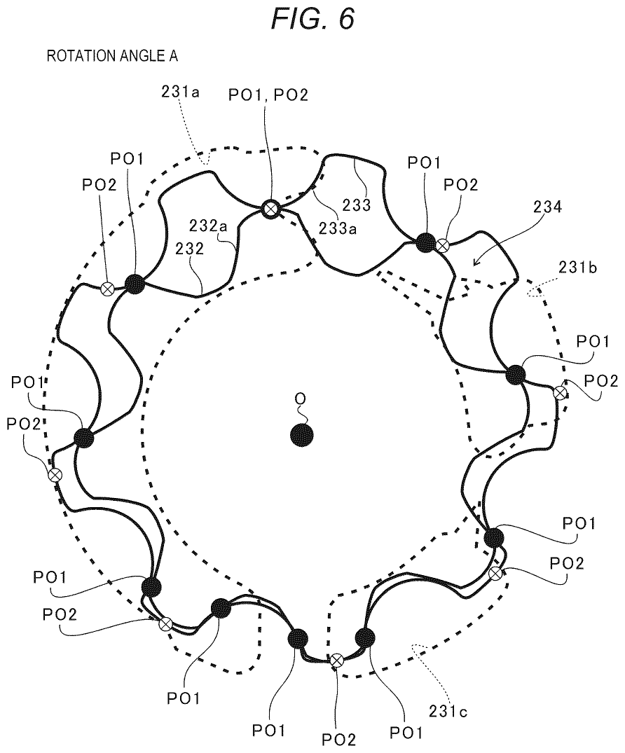

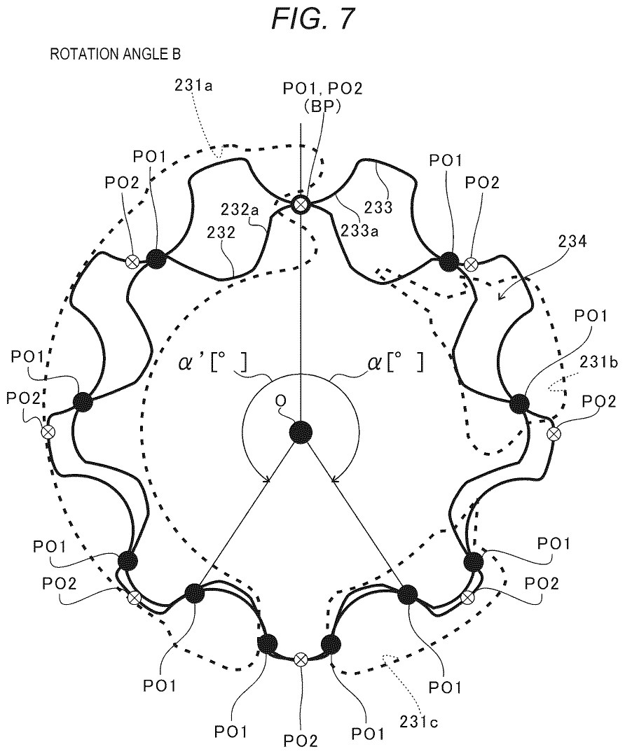

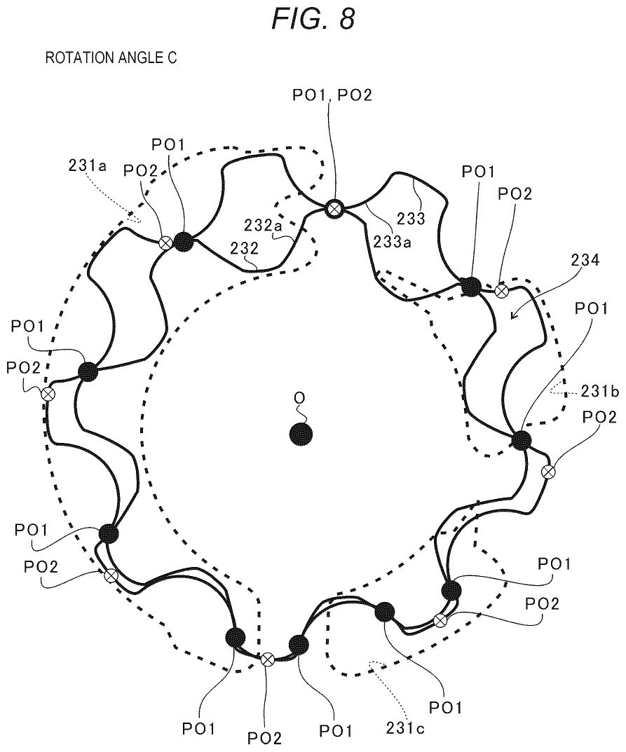

FIG. 6 is a schematic configuration diagram illustrating the first points and the second points of the inner rotor 232 and the outer rotor 233 at the predetermined rotation angle A. FIG. 7 is a schematic configuration diagram illustrating the first points and the second points of the inner rotor 232 and the outer rotor 233 at the predetermined rotation angle B. FIG. 8 is a schematic configuration diagram illustrating the first points and the second points of the inner rotor 232 and the outer rotor 233 at the predetermined rotation angle C. In FIGS. 6, 7, and 8, the first points are indicated by the black circles PO1, and the second points are indicated by white circles PO2 with a cross inside.

As illustrated in FIG. 6, at the rotation angle A, when the chamber 234 is divided into sub-chambers by connection lines connecting the center point O and the first points PO1 and connection lines connecting the center point O and the second points PO2, the number of the sub-chambers 234 is 18. At a position where the first point PO1 and the second point PO2 overlap each other in the upper land, it is assumed that there is the minute sub-chamber 234 that is obtained by dividing the chamber 234 by a connection line connecting the first point PO1 and the center point O and a connection line connecting the second point PO2 and the center point O. At this time, the total number of the first points PO1 and the second points PO2 is 18. Positions and rotation angles of the inner rotor 232 and the outer rotor 233 are calculated to derive the second points PO2.

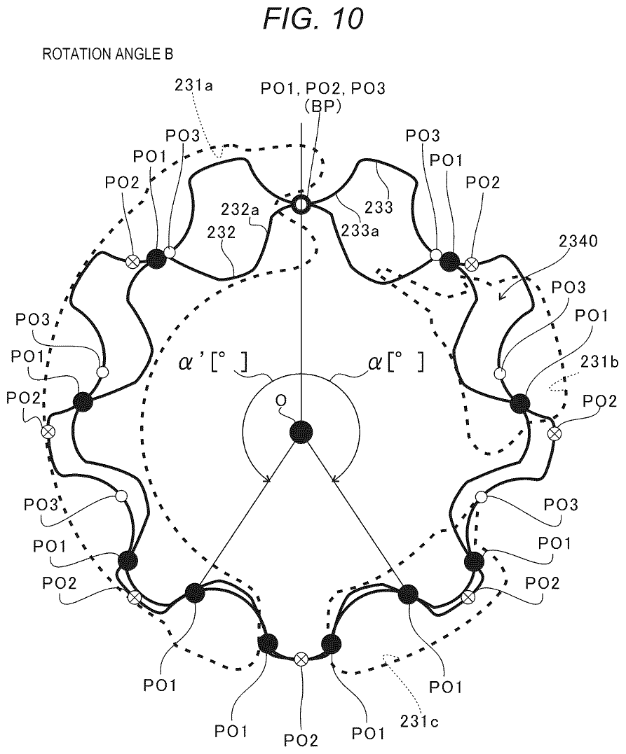

As illustrated in FIG. 7, at the rotation angle B, when the chamber 234 is divided into sub-chambers by connection lines connecting the center point O and the first points PO1 and connection lines connecting the center point O and the second points PO2, the number of the sub-chambers 234 is 19. At this time, the total number of the first points PO1 and the second points PO2 is 19. In FIG. 7, the second point PO2 is located at a position of 180[°] on the rotation direction side of the inner rotor 232 relative to the reference point BP. At this time, although the first point PO1 located at the second point PO2 is a contact point at which the inner rotor 232 and the outer rotor 233 come into contact with each other, the first point PO1 is not used as the division point and is invalidated. That is, when the first point PO1 and the second point PO2 overlap each other at the position of 180[°], the first point PO1 that overlaps the second point PO2 is not used as the division point and is invalidated. This also applies to FIG. 10, which will be described later.

As can be understood by comparing FIG. 6 and FIG. 7, when the inner rotor 232 and the outer rotor 233 move from the rotation angle A to the rotation angle B, the number of the first points PO1 increases by one at a position of the first specific angle α [ ] on the rotation direction side of the inner rotor 232 relative to the reference point BP. In this manner, when the inner rotor 232 and the outer rotor 233 move from the rotation angle A to the rotation angle B, the number of the first points PO1 increases by one in the lower land, and accordingly the number of the sub-chambers 234 also increases by one to be 19.

As illustrated in FIG. 8, at the rotation angle C, when the chamber 234 is divided into sub-chambers by connection lines connecting the center point O and the first points PO1 and connection lines connecting the center point O and the second points PO2, the number of the sub-chambers 234 is 18. At this time, the total number of the first points PO1 and the second points PO2 is 18.

As can be understood by comparing FIG. 7 and FIG. 8, when the inner rotor 232 and the outer rotor 233 move from the rotation angle B to the rotation angle C, the number of the first points PO1 decreases by one at a position of the second specific angle α′ [ ] on an opposite side to the rotation direction of the inner rotor 232 relative to the reference point BP. In this manner, when the inner rotor 232 and the outer rotor 233 move from the rotation angle B to the rotation angle C, the number of the first points PO1 decreases by one in the lower land, and accordingly the number of the sub-chambers 234 also decreases by one to be 18. Therefore, when the first points PO1 and the second points PO2 are set as the division points, an increase or decrease in the number of the sub-chambers 234 can be reduced to one as compared with when the first points PO1 are simply set as the division points. However, since the number of the sub-chambers 234 still varies, it is difficult to accurately predict the rotor behavior and the oil behavior of the oil pump 230. Therefore, in the present embodiment, in addition to the first points PO1 and the second points PO2, third points that change according to angles between the reference point BP and the second points PO2 are set as division points. As in the case of the second points PO2, the third points PO3 are set at positions on the inner peripheral surface of the outer rotor 233.

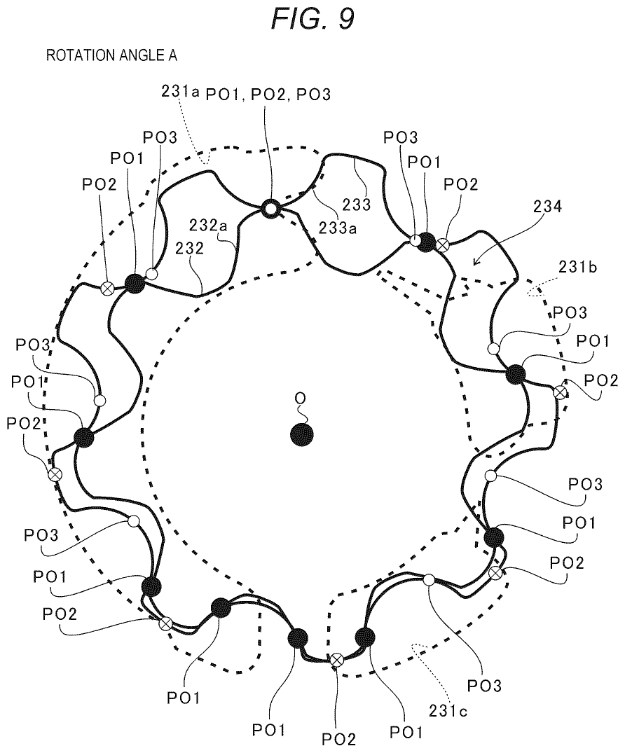

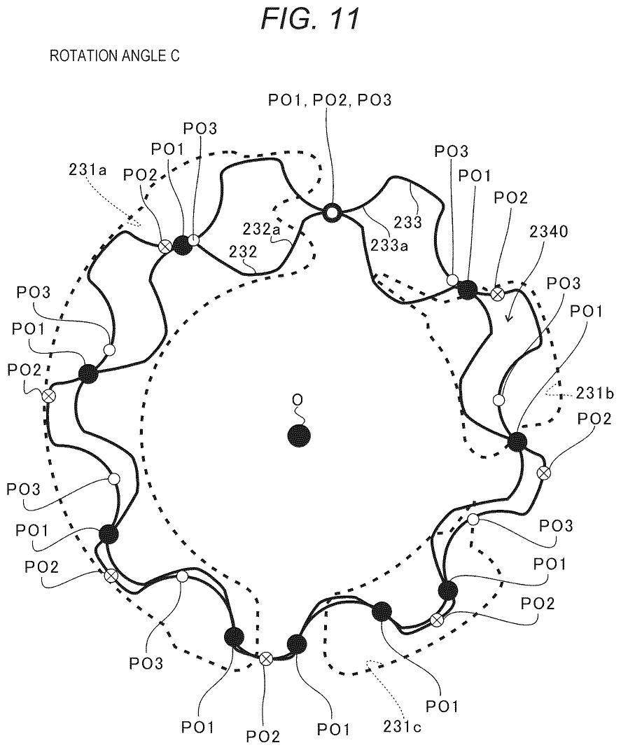

FIG. 9 is a schematic configuration diagram illustrating the first points, the second points, and the third points of the inner rotor 232 and the outer rotor 233 at the predetermined rotation angle A. FIG. 10 is a schematic configuration diagram illustrating the first points, the second points, and the third points of the inner rotor 232 and the outer rotor 233 at the predetermined rotation angle B. FIG. 11 is a schematic configuration diagram illustrating the first points, the second points, and the third points of the inner rotor 232 and the outer rotor 233 at the predetermined rotation angle C. In FIGS. 9, 10, and 11, the first points are indicated by the black circles PO1, the second points are indicated by the white circles PO2 with a cross inside, and the third points are indicated by white circles PO3.

As illustrated in FIG. 9, at the rotation angle A, when the chamber 234 is divided into sub-chambers by connection lines connecting the center point O and the first points PO1, connection lines connecting the center point O and the second points PO2, and connection line connecting the center point O and the third points PO3, the number of the sub-chambers 234 is 26. At a position where the first point PO1, the second point PO2, and the third point PO3 overlap one another in the upper land, it is assumed that there is the minute sub-chamber 234 obtained by dividing the chamber 234 by connection lines connecting (i) the center point O and (ii) the first point PO1, the second point PO2, and the third point PO3. At this time, the total number of the first points PO1, the second points PO2, and the third points PO3 is 26. In the present embodiment, although the total number of the first points PO1, the second points PO2, and the third points PO3 is 26, the total number changes according to the number of teeth of the inner rotor 232 and the outer rotor 233. The total number of the first points PO1, the second points PO2, and the third points PO3 is derived according to a formula of (the number of teeth of the outer rotor 233)×3−1. For example, in the present embodiment, since the number of teeth of the outer rotor 233 is 9, the total number is 26 according to 9×3-1.

As illustrated in FIG. 10, at the rotation angle B, when the chamber 234 is divided into sub-chambers by connection lines connecting the center point O and the first points PO1, connection lines connecting the center point O and the second points PO2, and connection lines connecting the center point O and the third points PO3, the number of the sub-chambers 234 is 26. At this time, the total number of the first points PO1, the second points PO2, and the third points PO3 is 26.

Here, a case where the inner rotor 232 and the outer rotor 233 move from the rotation angle A to the rotation angle B will be described by comparing FIG. 9 and FIG. 10. When the inner rotor 232 and the outer rotor 233 move from the rotation angle A to the rotation angle B, the number of the first points PO1 increases by one and the number of the third points PO3 decreases by one at a position of the first specific angle α [°] on the rotation direction side of the inner rotor 232 relative to the reference point BP.

In FIG. 10, the first point PO1 and the third point PO3 overlap each other at the position of the first specific angle α [°]. However, when the first point PO1 and the third point PO3 overlap each other, the third point PO3 that overlaps the first point PO1 is not used as the division point and is invalidated. That is, when the first point PO1 and the third point PO3 overlap each other, two division points that overlap each other are regarded as a single division point. Therefore, as described above, the number of the first points PO1 increases by one and the number of the third points PO3 decreases by one at the position of the first specific angle α [ ]. As a result, the number of the sub-chambers 234 at the rotation angle A and the number of the sub-chambers 234 at the rotation angle B are 26, that is, the number of the sub-chambers 234 does not change, and the total number of the first points PO1, the second points PO2, and the third points PO3 is 26 and does not change.

As illustrated in FIG. 11, at the rotation angle C, when the chamber 234 is divided into sub-chambers by connection lines connecting the center point O and the first points PO1, connection line connecting the center point O and the second points PO2, and connection lines connecting the center point O and the third points PO3, the number of the sub-chambers 234 is 26. At this time, the total number of the first points PO1, the second points PO2, and the third points PO3 is 26.

Herein, a case where the inner rotor 232 and the outer rotor 233 move from the rotation angle B to the rotation angle C will be described by comparing FIG. 10 and FIG. 11. When the inner rotor 232 and the outer rotor 233 move from the rotation angle B to the rotation angle C, the number of the first points PO1 decreases by one and the number of the third points PO3 increases by one at a position of the second specific angle a′ [°] on the opposite side to the rotation direction of the inner rotor 232 relative to the reference point BP.

In FIG. 10, the first point PO1 and the third point PO3 overlap each other at the position of the second specific angle α′ [ ]. However, when the first point PO1 and the third point PO3 overlap each other, the third point PO3 that overlaps the first point PO1 is not used as the division point and is invalidated. That is, when the first point PO1 and the third point PO3 overlap each other, two division points that overlap each other are regarded as a single division point. When the first point PO1 and the third point PO3 do not overlap each other, the third point PO3 that does not overlap the first point PO1 is validated and used as the division point. That is, when the first point PO1 and the third point PO3 do not overlap each other, the first point PO1 and the third point PO3 are regarded as different division points. Therefore, as described above, the number of the first points PO1 decreases by one and the number of the third points PO3 increases by one at the position of the second specific angle α′ [ ]. As a result, the number of the sub-chambers 234 at the rotation angle B and the number of the sub-chambers 234 at the rotation angle C are 26, that is, the number of the sub-chambers 234 does not change, and the total number of the first points PO1, the second points PO2, and the third points PO3 is 26 and does not change. In this manner, according to the present embodiment, the number of the sub-chambers 234 can be maintained constant regardless of rotation of the inner rotor 232 and the outer rotor 233. Therefore, the predetermined sub-chamber 234 that is calculated does not suddenly disappear or the sub-chamber 234 that is not calculated does not suddenly appear, which can prevent an error from occurring in the calculation of the volume of each sub-chamber 234. Since the number of the sub-chambers 234 is maintained constant, it is possible to continuously calculate a changing volume of each sub-chamber 234. As a result, the rotor behavior and the oil behavior of the oil pump 230 can be accurately predicted.

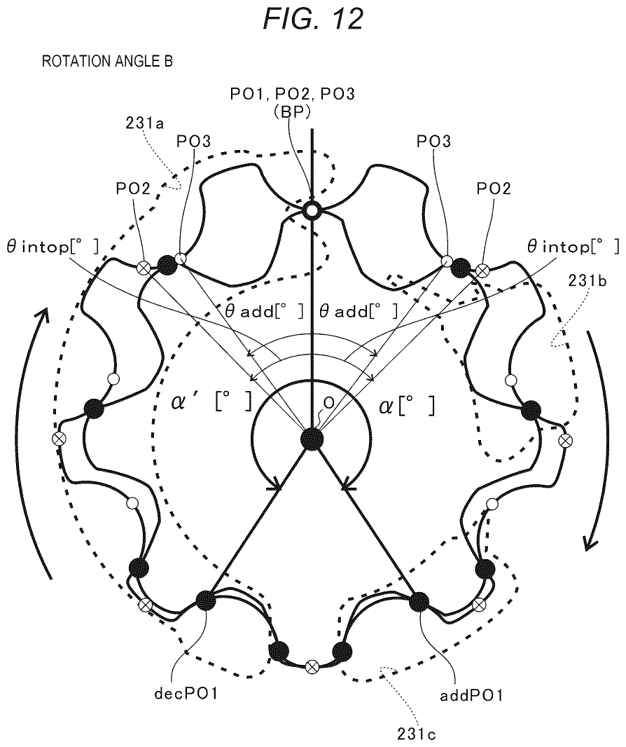

FIG. 12 is a diagram illustrating a method for setting the third points PO3. As illustrated in FIG. 12, an angle between the reference point BP and the third point PO3 is indicated by θadd [°], and an angle between the reference point BP and the second point PO2 is indicated by θintop [°]. An angle between the reference point BP and an increase contact point addPO1 at which the number of the first points PO1 increases is indicated by α [°], and an angle between the reference point BP and a decrease contact point decPO1 at which the number of the first points PO1 decreases is indicated by α′ [ ]. The angle α [°] is an angle in a range up to 180° on the rotation direction side of the inner rotor 232 relative to the reference point BP. The angle α′ [ ] is an angle in a range up to 180° on the opposite side to the rotation direction of the inner rotor 232 relative to the reference point BP. The angles α [ ] and x′ [ °] are angles other than 180[°].

In this case, the third points PO3 are set according to a formula of θadd=(x/180) θintop in the range up to 180° on the rotation direction side of the inner rotor 232 relative to the reference point BP. The third points PO3 are set according to a formula of θadd=(x′/180) θintop in a range up to 180° on the opposite side to the rotation direction of the inner rotor 232 relative to the reference point BP.

Setting the third points PO3 in this manner makes it possible to make the first points PO1 and the third points PO3 overlap each other at the angles α [°] and α′ [ ]. When the first point PO1 and the third point PO3 overlap each other, the third point PO3 that overlaps the first point PO1 is not used as the division point and is invalidated, so that the number of the sub-chambers 234 can be maintained unchanged.

In the present embodiment, the analyzer 300 derives volumes of the sub-chambers 234 that are obtained by dividing the chamber 234 into sub-chambers by the connection lines between the first points PO1 and the center point O, the connection lines between the second points PO2 and the center point O, and the connection lines between the third points PO3 and the center point O. The volumes of the sub-chambers 234 are derived in sequence according to a rotation angle of the inner rotor 232 and the outer rotor 233. In the present embodiment, since the number of the sub-chamber 234 is maintained unchanged according to the rotation angle of the inner rotor 232 and the outer rotor 233, a changing volume of each sub-chamber 234 can be derived continuously with high accuracy. Therefore, the analyzer 300 derives, in sequence, volume changes of the sub-chambers 234 according to the rotation angle of the inner rotor 232 and the outer rotor 233 with high accuracy.

The analyzer 300 derives a gap amount between each sub-chamber 234 by calculating positions and rotation angles of the inner rotor 232 and the outer rotor 233. The analyzer 300 also derives overlapping areas of overlapping portions where each sub-chamber 234 overlaps the intake port 231a, the main discharge port 231b, and the sub-discharge port 231c. The overlapping areas are derived in sequence according to a rotation angle of the inner rotor 232 and the outer rotor 233. Therefore, the analyzer 300 derives in sequence overlapping area changes according to the rotation angle of the inner rotor 232 and the outer rotor 233. Then, the analyzer 300 derives pressure of oil in each sub-chamber 234 based on the volume of each sub-chamber 234 and the derived overlapping areas.

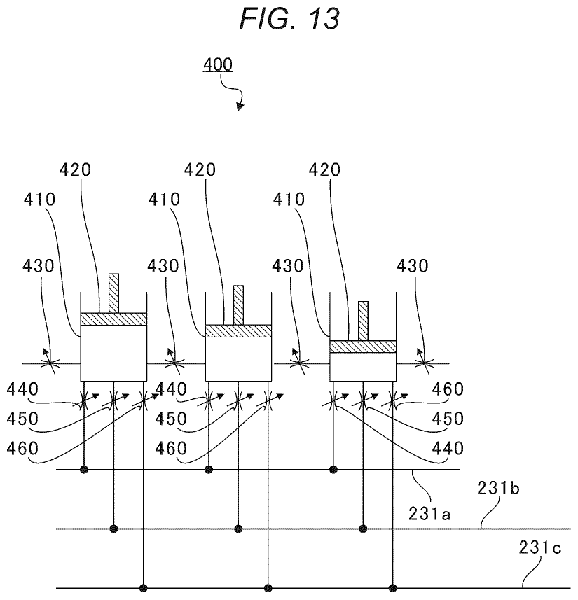

FIG. 13 is a schematic configuration diagram illustrating an example of a model 400 for deriving pressure of oil according to the present embodiment. As illustrated in FIG. 13, the model 400 includes plural cylinders 410, plural pistons 420, first variable diaphragms 430, second variable diaphragms 440, third variable diaphragms 450, and fourth variable diaphragms 460.

In the model 400, a volume of each sub-chamber 234 is used as a volume of a space between each cylinder 410 and each piston 420. A gap amount between the adjacent sub-chambers 234 is used as a diaphragm amount of the first variable diaphragm 430.

An overlapping area of an overlapping portion where each sub-chamber 234 and the intake port 231a overlap with each other is used as a diaphragm amount of the second variable diaphragm 440. An overlapping area of an overlapping portion where each sub-chamber 234 and the main discharge port 231b overlap each other is used as a diaphragm amount of the third variable diaphragm 450. An overlapping area of an overlapping portion where each sub-chamber 234 and the sub-discharge port 231c overlap each other is used as a diaphragm amount of the fourth variable diaphragm 460.

The model 400 can be used to derive an inflow amount and an outflow amount of oil to each sub-chamber 234. At this time, a pressure loss and a flow rate change of pipe portions in the intake passage 220, the main discharge passage 240, the sub-discharge passage 250, and the joint passage 260 may be derived. Since a volume change of each sub-chamber 234 can be continuously derived, and the inflow amount and the outflow amount of oil to each sub-chamber 234 can be derived, a pressure change of oil in each sub-chamber 234 can be continuously derived with high accuracy.

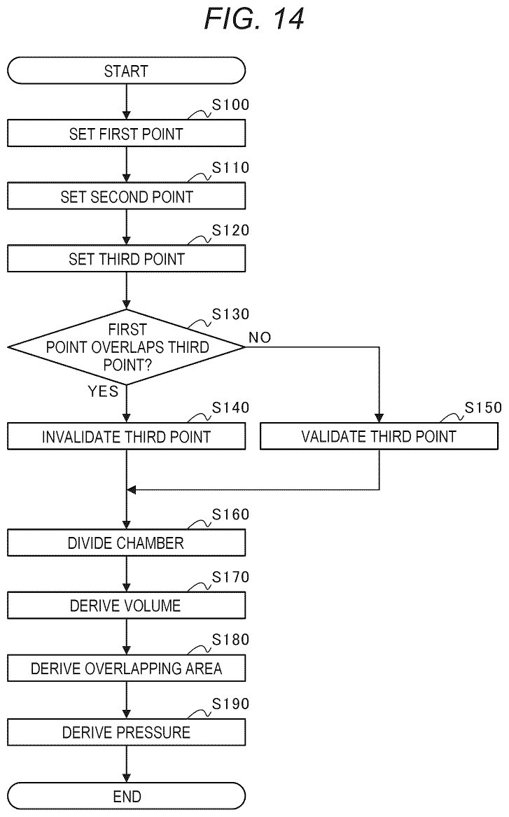

FIG. 14 is a flowchart illustrating an example of control processing executed by the analyzer 300 according to the present embodiment. The flowchart in FIG. 14 is executed each time the rotation angle of the inner rotor 232 and the outer rotor 233 changes. As illustrated in FIG. 14, first, the setting unit 300a sets, as division points, the first points PO1 at which the inner rotor 232 and the outer rotor 233 come into contact with each other (step S100). Next, the setting unit 300a sets, as division points, the second points PO2 that are located on the inner peripheral surface of the outer rotor 233 and located on an extension lines connecting the center point O of the inner rotor 232 and apexes of the external teeth 232a (step S110). Then, the setting unit 300a sets, as division points, the third points PO3 that change according to angles between the reference point BP and the second points PO2 on the inner peripheral surface of the outer rotor 233 (step S120).

Then, the setting unit 300a determines whether a first point PO1 and a third point PO3 overlap each other (step S130). When the first point PO1 and the third point PO3 overlap each other (step S130: YES), the setting unit 300a does not use the third point PO3 that overlaps the first point PO1 as the division point and invalidates the third point PO3 (step S140). On the other hand, when the first point PO1 and the third point PO3 do not overlap each other (step S130: NO), the setting unit 300a validates the third point PO3 as the division point, and uses the first point PO1 and the third point PO3 as the division points (step S150). The dividing unit 300b divides the chamber 234 into sub-chambers by connection lines each connecting the division points of the first points PO1, the second points PO2, and the third points PO3 and the center point O (step S160). At this time, when the first point PO1 and the third point PO3 overlap each other, the dividing unit 300b divides the chamber 234 without using the third point PO3 that overlaps the first point PO1 as the division point.

The deriving unit 300c derives volumes of the sub-chambers 234 obtained by dividing the chamber 234 using the first points PO1, the second points PO2, and the third points PO3 (step S170). The deriving unit 300c derives overlapping areas of overlapping portions where each sub-chamber 234 overlaps the intake port 231a, the main discharge port 231b, and the sub-discharge port 231c (step S180). Then, the deriving unit 300c uses the model 400 to derive pressure of each sub-chamber 234 based on the derived volumes and overlapping areas (step S190). The deriving unit 300c can continuously derive a pressure change of each sub-chamber 234 by continuously deriving the volume change and the overlapping area of each sub-chamber 234 according to the rotation angle of the inner rotor 232 and the outer rotor 233. As a result, the rotor behavior and the oil behavior of the oil pump 230 can be accurately predicted.

The embodiments of the disclosure have been described above with reference to the accompanying drawings. It is needless to say that the disclosure is not limited to such embodiments. It will be apparent to those skilled in the art that various changes and modifications may be conceived within the scope of the claims, and it is understood that such changes and modifications also fall within the technical scope of the disclosure.

A series of processing executed by each device (for example, the analyzer 300) according to the embodiment described above may be implemented using any one of software, hardware, or a combination of software and hardware. A program that constitutes the software is stored in advance in, for example, a non-transitory medium provided inside or outside each device. A program is read from, for example, a non-transitory storage medium (for example, a ROM) to a transitory storage medium (for example, a RAM), and is executed by a processor such as a CPU.

A program for implementing each function of each device described above can be created and installed in a computer of each device described above. A processor executes a program stored in a memory to execute processing of each function described above. At this time, a program may be shared and executed by plural processors, or a program may be executed by a single processor. Alternatively, a function of each device described above may be implemented by cloud computing using plural computers coupled to one another via a communication network.

A program may be provided to and installed in a computer of each device by distribution from an external device via a communication network. Alternatively, the program may be stored in a non-transitory computer readable storage medium, and provided to and installed in the computer of each device via the storage medium.

According to the present embodiment, it is possible to provide a program for executing processing of a function of each device described above. In addition, it is possible to provide a non-transitory computer readable storage medium that stores the program. The non-transitory storage medium may be, for example, a disk storage medium such as an optical disk, a magnetic disk, or a magneto-optical disk, or may be a semiconductor memory such as a flash memory or a USB memory.

According to the disclosure, it is possible to accurately predict a rotor behavior and an oil behavior of an oil pump.

1. An analyzer comprising:
at least one processor; and
at least one memory coupled to the at least one processor, wherein
the at least one processor is configured to
set, as a division point, a first point at which an inner rotor and an outer rotor of a pump come into contact with each other,
set, as the division point, a second point on the outer rotor, the second point being located on an extension line connecting a center of the inner rotor and an apex of the inner rotor,
set, as the division point, a third point that changes according to an angle between a reference point and the second point,
divide a chamber between the inner rotor and the outer rotor into sub-chambers by connection lines connecting (i) the center of the inner rotor and (ii) the first point, the second point, and the third point respectively, and
when the first point and the third point overlap each other, divide the chamber without the third point overlapping the first point as the division point.

2. The analyzer according to claim 1, wherein
in a range up to 180° on a rotation direction side of the inner rotor relative to the reference point, the processor is configured to set the third point according to
θadd=(α′/180)θintop, and
in a range up to 180° on an opposite side to a rotation direction of the inner rotor relative to the reference point, the processor is configured to set the third point according to
θadd=(α′/180)θintop,
where θadd is an angle between the reference point and the third point,
θintop is an angle between the reference point and the second point,
α is an angle between the reference point and an increase contact point at which the number of contact points between the inner rotor and the outer rotor increases due to rotation of the inner rotor and the outer rotor, and
α′ is an angle between the reference point and a decrease contact point at which the number of contact points between the inner rotor and the outer rotor decreases due to the rotation of the inner rotor and the outer rotor.

3. The analyzer according to claim 1, wherein
the at least one processor is configured to
derive a volume of each of the sub-chambers obtained by the division using the first point, the second point, and the third point,
derive an area of an overlapping portion where each of the sub-chambers overlaps an intake port and a discharge port of the pump, and
derive pressure of each of the sub-chambers based on the volume and the area.

4. The analyzer according to claim 2, wherein
the at least one processor is configured to
derive a volume of each of the sub-chambers obtained by the division using the first point, the second point, and the third point,
derive an area of an overlapping portion where each of the sub-chambers overlaps an intake port and a discharge port of the pump, and
derive pressure of each of the sub-chambers based on the volume and the area.
